(19) United States
(12) Patent Application Publication
(10) Pub. No.: US 2017/0004518 A1
(43) Pub. Date: Jan. 5, 2017

(54) METHOD AND SYSTEM FOR PROVIDING INTEGRATED SOLUTIONS

(71) Applicant: MASTERCARD INTERNATIONAL INCORPORATED, Purchase, NY (US)

(72) Inventor: Abner E. Moreau, JR., New York, NY (US)

(21) Appl. No.: 14/755,822

(22) Filed: Jun. 30, 2015

(51) Int. Cl. G06Q 30/02; G06Q 10/06

(52) U.S. Cl. CPC G06Q 30/0204; G06Q 10/06393; G06Q 30/0282

(57) ABSTRACT

A method and system that includes providing one or more databases configured to store a first set of information comprising microeconomic information and macroeconomic information, in which the microeconomic information comprises at least payment card holder transaction information at a merchant; generating, from the first set of information, insights into the business of the merchant; identifying a first set of opportunities and/or recommendations, based on the insights, for the business of the merchant; performing operational aspects for implementing the first set of opportunities and/or recommendations into the business of the merchant; measuring performance of the business of the merchant by comparing performance metrics prior to and after implementing the first set of opportunities and/or recommendations into the business of the merchant; and identifying a second set of opportunities and/or recommendations, based on performance measurement from the comparison of the performance metrics, for the business of the merchant.

### BACKGROUND OF THE DISCLOSURE

1. Field of the Disclosure

The present disclosure relates to a method and system for providing integrated solutions to merchants. In particular, the present disclosure relates to a closed loop method and system for providing integrated solutions to merchants utilizing data driven insights, opportunity identification and recommendations, execution, and data driven performance reporting. The closed loop method and system afford a more focused identification of opportunities and/or recommendations for the business of a merchant, benefiting from the use of the information generated during each cycle.

2. Description of the Related Art

Merchants, manufacturers and service providers are being forced to commit significant effort and capital to understanding how to improve on (a) determining who is buying their product, why, when and where; (b) selling the right product in the right marketplace; (c) gleaning consumer feedback to try and improve their products and services or to design new ones; (d) targeting the consumers that buy the most, most frequently and most recently; and (e) targeting those customers that are most likely to buy.

Analytics and the information required for effective analyses have seen a more significant role given the situation consumer-oriented companies find themselves in at present. In an effort to stay competitive, companies spend a large portion of their revenues on warehousing and analyzing their own data.

However, gaining real insight into customer behavior is still an extremely difficult goal to achieve since causality and predictability are very hard to infer from just company specific sales and inventory data.

In an example, companies spend marketing dollars across a range of different mediums, both nationally and locally. This activity is designed to build awareness, induce prospects to buy and build greater loyalty in existing customers. Yet, for each marginal dollar spent, companies do not know if they have spent money on the best medium, in the right setting (local or national), directed towards the right customers, whether prospects or repeat buyers. Thus, a company does not truly know if their advertising efforts are effective.

Typically, companies measure media effectiveness by awareness, which is loosely correlated with bottom line profits and loss impact. Companies measure impact through changes in attitudes, which are also loosely correlated with actual purchase intent and behavior, and therefore, bottom line profits and loss impact. Companies measure results from a lift in sales but with little ability to understand whether a customer's behavior is really changing over time. The inability to measure a customer's behavior over time and tie consumers' behavior to marketing makes it difficult to determine the optimal marketing mix choice of product, price, positioning, and packaging.

This lack of clarity is a major problem. Even with a measurable medium, such as, local, store-specific and product specific offers, which is fairly easy to measure, companies can measure response but have a hard time understanding what is really driving consumer behavior and therefore, the real bottom line impact of the dollars spent. Also, while companies measure response to a specific promotion, e.g., a coupon, they cannot determine if the coupon itself induced a purchase or what it means for the next time a similar purchase occasion arises for a customer.

Marketing is just one part of a company's expenses that is tied to its bottom line. Merchandising, operations, customer service are all part of the offering that a company makes to its customers and prospects. In addition to media expenditure, companies commit large amounts of money to investments in branding, marketing research, product development, distribution planning and site location, prospecting and acquiring customers. Each is a significant activity but similar uncertainty as to the effectiveness of decisions made with respect to these areas exists. Information is the critical ingredient needed to make accurate and knowledgeable decisions in all these areas. Any information and analysis that better informs a company such that it can make a more accurate and correct decision along any of its activities is extremely valuable. Most important is real-time detailed information that allows a company to measure and therefore better predict consumer behavior, relative to the market, in response to specific changes in its offerings.

There is a need for information that can inform all types of business decision making, in particular, information that defines a company's need including performance tracking, media tracking and effectiveness, product assortment and pricing management, location/market optimization, and consumer needs and insight. There is a need for real-time detailed information that allows a company to measure and therefore better predict consumer behavior, relative to the market, in response to specific changes in its offerings.

### SUMMARY OF THE DISCLOSURE

The present disclosure relates to a method and system for providing integrated solutions to merchants. In particular, the present disclosure relates to a closed loop method and system for providing integrated solutions to merchants utilizing data driven insights, opportunity identification and recommendations, execution, and data driven performance reporting. The closed loop method and system afford a more focused identification of opportunities and/or recommendations for the business of a merchant, benefiting from the use of the information generated during each cycle.

The present disclosure also provides a method that includes providing one or more databases configured to store a first set of information comprising microeconomic information and macroeconomic information, in which the microeconomic information comprises at least payment card holder transaction information at one or more merchants; generating, from the first set of information, one or more insights into the business of the one or more merchants; identifying a first set of opportunities and/or recommendations, based on the one or more insights, for the business of the one or more merchants; performing operational aspects for implementing the first set of opportunities and/or recommendations into the business of the one or more merchants; measuring performance of the business of the one or more merchants by comparing one or more performance metrics prior to implementing the first set of opportunities and/or recommendations into the business of the one or more merchants with the one or more performance metrics after implementing the first set of opportunities and/or recommendations into the business of the one or more merchants; and identifying a second set of opportunities and/or recommendations, based on performance measurement from the comparison of the one or more performance metrics, for the business of the one or more merchants.

The method of this disclosure is a closed loop method in which the generated insights into the business of the merchant, the identified opportunities and/or recommendations for the business of the merchant, the performed operational aspects for implementing the opportunities and/or recommendations into the business of the merchant, the performance measures of the business of the merchant, and any other information generated in one cycle can be incorporated into the one or more databases and used in the next or subsequent cycles.

The present disclosure further provides system that includes one or more databases configured to store a first set of information comprising microeconomic information and macroeconomic information, in which the microeconomic information comprises at least payment card holder transaction information at one or more merchants; a processor configured to: generate, from the first set of information, one or more insights into the business of the one or more merchants; identify a first set of opportunities and/or recommendations, based on the one or more insights, for the business of the one or more merchants; perform operational aspects for implementing the first set of opportunities and/or recommendations into the business of the one or more merchants; measure performance of the business of the one or more merchants by comparing one or more performance metrics prior to implementing the first set of opportunities and/or recommendations into the business of the one or more merchants with the one or more performance metrics after implementing the first set of opportunities and/or recommendations into the business of the one or more merchants; and identify a second set of opportunities and/or recommendations, based on performance measurement from the comparison of the one or more performance metrics, for the business of the one or more merchants.

The processor is configured to carry out a closed loop method in which the generated insights into the business of the merchant, the identified opportunities and/or recommendations for the business of the merchant, the performed operational aspects for implementing the opportunities and/or recommendations into the business of the merchant, the performance measures of the business of the merchant, and any other information generated in one cycle can be incorporated into the one or more databases and used in the next or subsequent cycles.

The present disclosure yet further provides a method for generating one or more predictive business models. The method includes providing one or more databases configured to store a first set of information comprising microeconomic information and macroeconomic information, in which the microeconomic information comprises at least payment card holder transaction information at one or more merchants; generating, from the first set of information, one or more insights into the business of the one or more merchants; identifying a first set of opportunities and/or recommendations, based on the one or more insights, for the business of the one or more merchants; performing operational aspects for implementing the first set of opportunities and/or recommendations into the business of the one or more merchants; measuring performance of the business of the one or more merchants by comparing one or more performance metrics prior to implementing the first set of opportunities and/or recommendations into the business of the one or more merchants with the one or more performance metrics after implementing the first set of opportunities and/or recommendations into the business of the one or more merchants; identifying a second set of opportunities and/or recommendations, based on the comparison of the one or more performance metrics, for the business of the one or more merchants; and generating one or more predictive business models based on performance measurement from the comparison of the one or more performance metrics.

The method for generating one or more predictive business models of this disclosure is a closed loop method in which the generated insights into the business of the merchant, the identified opportunities and/or recommendations for the business of the merchant, the performed operational aspects for implementing the opportunities and/or recommendations into the business of the merchant, the performance measures of the business of the merchant, the generated predictive business models, and any other information generated in one cycle can be incorporated into the one or more databases and used in the next or subsequent cycles.

### BRIEF DESCRIPTION OF THE DRAWINGS

FIG. 1 is a diagram of a four party payment card system.

FIG. 2 illustrates a data warehouse shown in FIG. 1 that is a central repository of data that is created by storing certain transaction data from transactions occurring in four party payment card system of FIG. 1.

FIG. 3 shows illustrative information types used in the systems and the methods of the present disclosure.

FIG. 4 illustrates an exemplary dataset for the storing, reviewing, and/or analyzing of information used in the systems and the methods of the present disclosure.

FIG. 5 illustrates an exemplary strategic framework for delivering integrated solutions in accordance with the systems and the methods of the present disclosure.

FIG. 6 is a block diagram illustrating a method for identifying opportunities and/or recommendations for the business of the one or more merchants in accordance with exemplary embodiments of this disclosure.

FIG. 7 is a block diagram illustrating a method for generating one or more predictive business models in accordance with exemplary embodiments of this disclosure.

A component or a feature that is common to more than one drawing is indicated with the same reference number in each drawing.

### DESCRIPTION OF THE EMBODIMENTS

Embodiments of the present disclosure are described more fully hereinafter with reference to the accompanying drawings, in which some, but not all, embodiments of the disclosure are shown. Indeed, the disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

As used herein, the one or more databases configured to store the first set of information or from which the first set of information is retrieved, and the one or more databases configured to store the second set of information or from which the second set of information is retrieved, and the one or more databases configured to store the third set of information or from which the third set of information is retrieved, can be the same or different databases.

As used herein, cycle means performing all or part of the steps in the closed loop method of this disclosure, in particular, providing one or more databases configured to store a first set of information comprising microeconomic information and macroeconomic information, in which the microeconomic information comprises at least payment card holder transaction information at one or more merchants; generating, from the first set of information, one or more insights into the business of the one or more merchants; identifying a first set of opportunities and/or recommendations, based on the one or more insights, for the business of the one or more merchants; performing operational aspects for implementing the first set of opportunities and/or recommendations into the business of the one or more merchants; measuring performance of the business of the one or more merchants by comparing one or more performance metrics prior to implementing the first set of opportunities and/or recommendations into the business of the one or more merchants with the one or more performance metrics after implementing the first set of opportunities and/or recommendations into the business of the one or more merchants; and identifying a second set of opportunities and/or recommendations, based on performance measurement from the comparison of the one or more performance metrics, for the business of the one or more merchants. The generated insights into the business of the merchant, the identified opportunities and/or recommendations for the business of the merchant, the performed operational aspects for implementing the opportunities and/or recommendations into the business of the merchant, the performance measures of the business of the merchant, and any other information generated in one cycle can be incorporated into the one or more databases and used in the next or subsequent cycles.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage device, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

Thus, systems, methods and computer programs are herein disclosed to provide one or more databases configured to store a first set of information comprising microeconomic information and macroeconomic information, in which the microeconomic information comprises at least payment card holder transaction information at one or more merchants. The systems, methods and computer programs generate, from the first set of information, one or more insights into the business of the one or more merchants, and identify a first set of opportunities and/or recommendations, based on the one or more insights, for the business of the one or more merchants. Further, the systems, methods and computer programs perform operational aspects for implementing the first set of opportunities and/or recommendations into the business of the one or more merchants, and measure performance of the business of the one or more merchants by comparing one or more performance metrics prior to implementing the first set of opportunities and/or recommendations into the business of the one or more merchants with the one or more performance metrics after implementing the first set of opportunities and/or recommendations into the business of the one or more merchants. The systems, methods and computer programs also identify a second set of opportunities and/or recommendations, based on performance measurement from the comparison of the one or more performance metrics, for the business of the one or more merchants.

Among many potential uses, the systems and methods described herein can be used to: (1) identify for merchants where shopper volume is coming from; this identification can be geospatially from regions down to each individual store location; (2) compare and contrast payment card holder spend at a merchant relative to total payment card holder spend with competitors in the industry (or the competition); (3) determine how seasonality and special events impact purchasing behavior at the merchant; (4) develop insights and actions to enhance merchants in staffing/customer service, as well as inventory/stocking in their stores to reflect changing market trends; (5) advertise at the proper media and industry to promote their brand where opportunities exist; and (6) understand if the merchant is performing better or worse in their industry than the competition.

Further, the systems and methods described herein can be used to: (1) allow a merchant, for example, to gear advertising towards certain consumers to increase shopper flow and transactions; (2) allow a merchant to enhance the shopper experience with special sales, discounts, financing, and the like; (3) allow merchants to plan according to shopper arrival seasonality at a particular destination site (e.g., if the destination site is closed in May, and yet May has the most shoppers entering the region, then the destination site schedule can be adjusted); and (4) allow merchants to better target customers and/or enhance existing customer relationships. Other uses are possible.

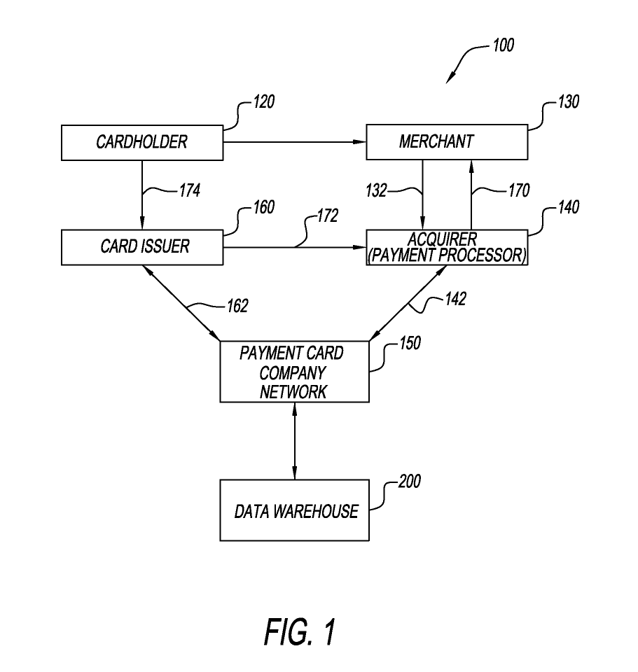

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes a financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, if the transaction is approved, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

Data warehouse 200 is a database used by payment card company network 150 for reporting and data analysis. According to one embodiment, data warehouse 200 is a central repository of data that is created by storing certain transaction data from transactions occurring within four party payment card system 100. According to another embodiment, data warehouse 200 stores, for example, the date, time, amount, location, merchant code, and merchant category for every transaction occurring within payment card network 150.

In yet another embodiment, data warehouse 200 stores, reviews, and/or analyzes information used in (i) assessing purchasing and payment activities of the payment card holders; (ii) assessing microeconomic and macroeconomic information that can influence purchasing and payment activities of the payment card holders; and (iii) assessing purchasing and payment behavior of the payment card holders at one or more merchants based on the purchasing and payment activities of the payment card holders.

In yet another embodiment, data warehouse 200 stores, reviews, and/or analyzes information used in generating one or more insights into the business of the one or more merchants based on the microeconomic information and macroeconomic information, including the payment card holder transaction information at the one or more merchants. The one or more insights into the business of the one or more merchants can include, for example, one or more of spending patterns, customer profiles, competitor performance, market trends, and the like.

In yet another embodiment, data warehouse 200 stores, reviews, and/or analyzes information used in identifying opportunities and/or recommendations for the business of the one or more merchants, based on the one or more insights. The opportunities and/or recommendations for the business of the one or more merchants can include, for example, implementing a marketing campaign to take advantage of a market trend, making targeted promotional offers to a plurality of payment card holders, and the like.

In yet another embodiment, data warehouse 200 stores, reviews, and/or analyzes information used in performing operational aspects for implementing the opportunities and/or recommendations into the business of the one or more merchants. The operational aspects can include, for example, providing metrics to the one or more merchants for one or more of spending patterns, customer profiles, competitor performance, and market trends, including payment card usage trends, alerting the one or more merchants of changes in one or more of spending patterns, customer profiles, competitor performance, and market trends, including payment card usage trends, and the like.

In yet another embodiment, data warehouse 200 stores, reviews, and/or analyzes information used in measuring performance of the business of the one or more merchants by comparing one or more performance metrics prior to implementing the opportunities and/or recommendations into the business of the one or more merchants with the one or more performance metrics after implementing the opportunities and/or recommendations into the business of the one or more merchants. The one or more performance metrics can include, for example, one or more of financial performance, customer base, product set, cost of goods, cost of advertising, geographical activities, and the like.

In yet another embodiment, data warehouse 200 stores, reviews, and/or analyzes information used in identifying additional opportunities and/or recommendations for the business of the one or more merchants, based on performance measurement from the comparison of the one or more performance metrics. The additional opportunities and/or recommendations for the business of the one or more merchants can include, for example, implementing a differently focused marketing campaign to take advantage of a market trend, making different targeted promotional offers to a plurality of payment card holders, and the like.

In yet another embodiment, data warehouse 200 stores, reviews, and/or analyzes information used in generating one or more predictive business models based on performance measurement from the comparison of the one or more performance metrics. The one or more predictive business models assist the one or more merchants in making strategic business decisions, for example, strategic business decisions that take into account spending patterns, customer profiles, competitor performance, market trends, and the like.

In yet still another embodiment, data warehouse 200 stores, reviews, and/or analyzes information used in creating one or more datasets to store information relating to (i) purchasing and payment activities of the payment card holders; (ii) purchasing and payment behavior of the payment card holders at one or more merchants based on the purchasing and payment activities of the payment card holders; (iii) one or more insights, generated from the first set of information, into the business of the one or more merchants, (iv) opportunities and/or recommendations, generated from the one or more insights, for the business of the one or more merchants, (v) operational aspects performed to implement the opportunities and/or recommendations into the business of the one or more merchants, (vi) business performance measurement information of one or more merchants generated by comparison of the one or more performance metrics, (vii) opportunities and/or recommendations, generated from the business performance measurement information, for the business of the one or more merchants, and (viii) one or more predictive business models based on performance measurement from the comparison of the one or more performance metrics.

In another embodiment, data warehouse 200 stores, reviews, and/or analyzes information used in developing logic for (i) purchasing and payment activities of the payment card holders; (ii) purchasing and payment behavior of the payment card holders at one or more merchants based on the purchasing and payment activities of the payment card holders; (iii) one or more insights, generated from the first set of information, into the business of the one or more merchants, (iv) opportunities and/or recommendations, generated from the one or more insights, for the business of the one or more merchants, (v) operational aspects performed to implement the opportunities and/or recommendations into the business of the one or more merchants, (vi) business performance measurement information of one or more merchants generated by comparison of the one or more performance metrics, (vii) opportunities and/or recommendations, generated from the business performance measurement information, for the business of the one or more merchants, and (viii) one or more predictive business models based on performance measurement from the comparison of the one or more performance metrics.

In still another embodiment, data warehouse 200 stores, reviews, and/or analyzes information used in quantifying the strength and/or accuracy of the (i) purchasing and payment activities of the payment card holders; (ii) purchasing and payment behavior of the payment card holders at one or more merchants based on the purchasing and payment activities of the payment card holders; (iii) one or more insights, generated from the first set of information, into the business of the one or more merchants, (iv) opportunities and/or recommendations, generated from the one or more insights, for the business of the one or more merchants, (v) operational aspects performed to implement the opportunities and/or recommendations into the business of the one or more merchants, (vi) business performance measurement information of one or more merchants generated by comparison of the one or more performance metrics, (vii) opportunities and/or recommendations, generated from the business performance measurement information, for the business of the one or more merchants, and (viii) one or more predictive business models based on performance measurement from the comparison of the one or more performance metrics.

In still another embodiment, data warehouse 200 stores, reviews, and/or analyzes information used in targeting information including at least one or more suggestions, recommendations or opportunities for an entity (e.g., merchant), based on performance measurement from the comparison of the one or more performance metrics.

In another embodiment, data warehouse 200 aggregates the information by payment card holder, merchant, category and/or location. In still another embodiment, data warehouse 200 integrates data from one or more disparate sources. Data warehouse 200 stores current as well as historical data and is used for creating reports, performing analyses on the network, merchant analyses, and performing predictive analyses.

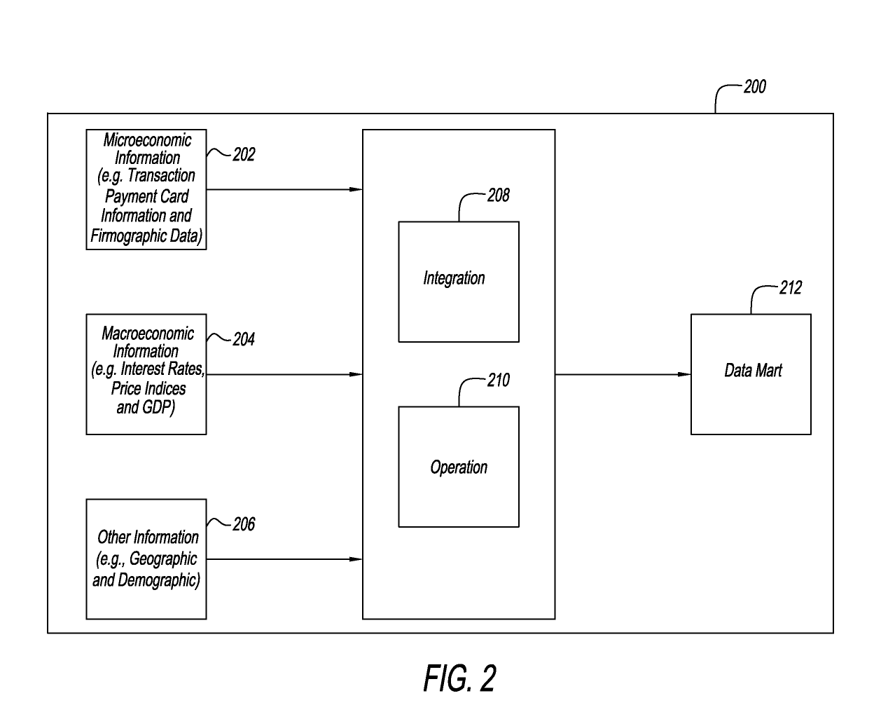

Referring to FIG. 2, an exemplary data warehouse 200 (the same data warehouse 200 in FIG. 1) for reporting and data analysis, including the storing, reviewing, and/or analyzing of information, for the various purposes described above is shown. The data warehouse 200 can have a plurality of entries (e.g., entries 202, 204 and 206).

In accordance with this disclosure, one or more databases are configured at 202 to store microeconomic information. The microeconomic information includes at least payment card holder transaction information, e.g., payment card billing, purchasing and payment transactions, provided by a payment card company (part of the payment card company network 150 in FIG. 1), merchant information, and firmographics data. At 204, one or more databases are configured to store macroeconomic information. The macroeconomic information includes, for example, gross domestic product (GDP), interest rates, price indices, unemployment rates, and the like.

The transaction payment card information at 202 can include, for example, payment card transaction information, payment card holder information, and purchasing and payment activities attributable to payment card holders, that can be aggregated by payment card holder, merchant category and/or location in the data warehouse 200. The transaction payment card information at 202 can also include, for example, a transaction identifier, geolocation of payment card transaction, geolocation date on which payment card transaction occurred, geolocation time on which payment card transaction occurred, and the like.

The merchant information at 202 can include, for example, categories of merchants, and the like. The merchant information at 202 can also include, for example, a merchant identifier, geolocation of merchant, firmographics data, and the like.

The firmographics data can include, for example, line of operations for a business, information related to employees, revenues and industries, and the like. In particular, the firmographics data relates to information on merchants that is typically used in credit decisions, business-to-business marketing and supply chain management.

Illustrative information in the firmographics data source includes, for example, information concerning merchant background, merchant history, merchant special events, merchant operation, merchant payments, merchant payment trends, merchant financial statement, merchant public filings, and the like merchant information.

Merchant background information can include, for example, ownership, history and principals of the merchant, and the operations and location of the merchant.

Merchant history information can include, for example, incorporation details, par value of shares and ownership information, background information on management, such as educational and career history and company principals, related companies including identification of affiliates including, but not limited to, parent, subsidiaries and/or branches worldwide. The merchant history information can also include corporate registration details to verify the existence of a registered organization, confirm legal information such as a merchant's organizational structure, date and state of incorporation, and research possible fraud by reviewing names of principals and business standing in a state.

Merchant special event information can include, for example, any developments that can impact a potential relationship with a company, such as bankruptcy filings, changes in ownership, acquisitions and other events. Other special event information can include announcements on the release of earnings reports. Special events can help explain unusual company trends, for example, a change in ownership could have an impact on manner of payment, or decreased production may reflect an unexpected interruption in factory operations (i.e., labor strike or fire).

Merchant operational information can include, for example, the identity of the parent company, the number of accounts and geographic scope of the business, typical selling terms, and whether the merchant owns or leases its facilities. The names and locations of branch operations and subsidiaries can also be identified.

Merchant payment information can include, for example, a listing of recent payments made by a company. An unusually large number of transactions during a single month or time period can indicate a seasonal purchasing pattern. The information can show payments received prior to date of invoice, payments received within trade discount period, payments received within terms granted, and payments beyond vendor's terms.

Merchant payment trend information can include, for example, information that spots trends in a merchant's business by analyzing how it pays its bills.

Merchant financial statement information can include, for example, a formal record of the financial activities and a snapshot of a merchant's financial health. Financial statements typically include four basic financial statements, accompanied by a management discussion and analysis. The Balance Sheet reports on a company's assets, liabilities, and ownership equity at a given point in time. The Income Statement reports on a company's income, expenses, and profits over a period of time. Profit & Loss accounts provide information on the operation of the enterprise. These accounts include sale and the various expenses incurred during the processing state. The Statement of Retained Earnings explains the changes in a company's retained earnings over the reporting period. The Statement of Cash Flows reports on a company's cash flow activities, particularly its operating, investing and financing activities.

Merchant public filing information can include, for example, bankruptcy filings, suits, liens, and judgment information obtained from Federal and State court houses for a company.

The other information 206 includes, for example, geographic data and demographic data. The other information 206 can include other suitable information that can be useful in (i) assessing purchasing and payment activities of the payment card holders; (ii) assessing microeconomic and macroeconomic information that can influence purchasing and payment activities of the payment card holders; and (iii) assessing purchasing and payment behavior of the payment card holders at one or more merchants based on the purchasing and payment activities of the payment card holders.

In particular, the other information can include, for example, geographic data, geographic areas (e.g., ZIP codes, metropolitan areas (metropolitan statistical area (MSA), designated market area (DMA), and the like), event venues, and the like), calendar information (e.g., open seasons such as beach seasons, ski seasons, and the like, retail calendar, seasonal/holiday information such as observances of shifting holidays such as Easter), weather (e.g., snowfall, rain, temperature, and the like), and the like. The other information affords leveraged data sources that can supplement information of 202 and 204.

Demographic information can also be used to supplement or leverage the information of 202 and 204. Illustrative demographic information includes, for example, age, income, presence of children, education, and the like.

The other information 206 can include suitable information that can be useful in (i) generating one or more insights into the business of the one or more merchants; (ii) identifying opportunities and/or recommendations, based on the one or more insights, for the business of the one or more merchants; (iii) performing operational aspects for implementing the first set of opportunities and/or recommendations into the business of the one or more merchants; (iv) measuring performance of the business of the one or more merchants by comparing one or more performance metrics prior to implementing the first set of opportunities and/or recommendations into the business of the one or more merchants with the one or more performance metrics after implementing the first set of opportunities and/or recommendations into the business of the one or more merchants; and (v) identifying opportunities and/or recommendations, based on performance measurement from the comparison of the one or more performance metrics, for the business of the one or more merchants.

With regard to the information of 202, 204 and 206, filters can be employed to select particular portions of the information. For example, time range filters can be used that can vary based on need or availability.

In an embodiment, all information stored in each of the one or more databases (e.g., 202, 204 and 206) can be retrieved. In another embodiment, only a single entry in each database can be retrieved. The retrieval of information can be performed a single time, or can be performed multiple times. In an exemplary embodiment, only information pertaining to a specific index is retrieved from each of the databases.

The typical data warehouse uses staging, data integration, and access layers to house its key functions. The staging layer or staging database stores raw data extracted from each of the disparate source data systems. The integration layer integrates at 208 the disparate data sets by transforming the data from the staging layer often storing this transformed data in an operational data store database 210. For example, the payment card transaction information 202 can be aggregated by merchant, category and/or location at 208. Also, the reporting and data analysis, including the storing, reviewing, and/or analyzing of information, for the various purposes described above, can occur in data warehouse 200. The integrated data is then moved to yet another database, often called the data warehouse database or data mart 212, where the data is arranged into hierarchical groups often called dimensions and into facts and aggregate facts. The access layer helps users retrieve data.

A data warehouse constructed from an integrated data source systems does not require staging databases or operational data store databases. The integrated data source systems can be considered to be a part of a distributed operational data store layer. Data federation methods or data virtualization methods can be used to access the distributed integrated source data systems to consolidate and aggregate data directly into the data warehouse database tables. The integrated source data systems and the data warehouse are all integrated since there is no transformation of dimensional or reference data. This integrated data warehouse architecture supports the drill down from the aggregate data of the data warehouse to the transactional data of the integrated source data systems.

The data mart 212 is a small data warehouse focused on a specific area of interest. For example, the data mart 212 can be focused on one or more of reporting and data analysis, including the storing, reviewing, and/or analyzing of information, for any of the various purposes described above. Data warehouses can be subdivided into data marts for improved performance and ease of use within that area. Alternatively, an organization can create one or more data marts as first steps towards a larger and more complex enterprise data warehouse.

This definition of the data warehouse focuses on data storage. The main source of the data is cleaned, transformed, cataloged and made available for use by managers and other business professionals for data mining, online analytical processing, market research and decision support. However, the means to retrieve and analyze data, to extract, transform and load data, and to manage the data dictionary are also considered essential components of a data warehousing system. Many references to data warehousing use this broader context. Thus, an expanded definition for data warehousing includes business intelligence tools, tools to extract, transform and load data into the repository, and tools to manage and retrieve metadata.

Algorithms can be employed to determine formulaic descriptions of the integration of the data source information and/or generation of insights and opportunities and/or recommendations using any of a variety of known mathematical techniques. These formulas, in turn, can be used to derive or generate one or more analyses and updates for analyzing, creating, comparing and identifying activities using any of a variety of available trend analysis algorithms. For example, these formulas can be used in the reporting and data analysis, including the storing, reviewing, and/or analyzing of information, for the various purposes described above.

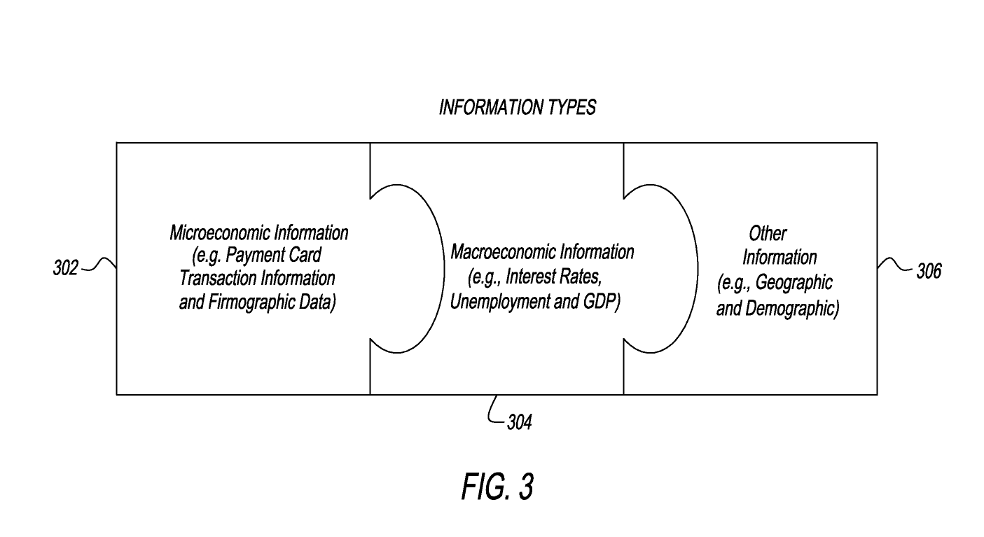

In accordance with the method of this disclosure, information that is stored in one or more databases can be retrieved (e.g., by a processor). FIG. 3 shows illustrative information types used in the systems and methods of this disclosure.

The microeconomic information at 302 includes at least payment card holder transaction information, e.g., payment card billing, purchasing and payment transactions, provided by a payment card company (part of the payment card company network 150 in FIG. 1), merchant information, and firmographics data. The macroeconomic information at 304 includes, for example, gross domestic product (GDP), interest rates, price indices, unemployment rates, and the like. The information at 302, 304 and 306 can be retrieved from one or more databases owned or controlled by an entity, for example, a payment card company (part of the payment card company network 150 in FIG. 1).

The transaction payment card information 302 can include, for example, payment card transaction information, payment card holder information (e.g., payment card holder account identifier (likely anonymized), payment card holder geography (potentially modeled), payment card holder type (consumer/business), payment card holder demographics, and the like), and purchasing and payment activities attributable to payment card holders, that can be aggregated by payment card holder, merchant category and/or location, transaction date and time, and transaction amount. The transaction payment card information 302 can also include, for example, a transaction identifier, geolocation of payment card transaction, geolocation date on which payment card transaction occurred, geolocation time on which payment card transaction occurred, and the like. Information for inclusion in the information of 302 can be obtained, for example, from payment card companies known as MasterCard®, Visa®, American Express®, and the like (part of the payment card company network 150 in FIG. 1).

The merchant information 302 can include, for example, categories of merchants, merchant name, merchant geography, merchant line of business, and the like. The merchant information 302 can also include, for example, a merchant identifier, geolocation of merchant, firmographics data, and the like.

One or more databases are used for storing information of one or more merchants, and merchants belonging to a particular category, e.g., industry category. Illustrative merchant categories are described herein. The merchant categorization is useful for generating one or more insights and one or more predictive business models based on performance measurement from the comparison of the one or more performance metrics.

In an embodiment, a merchant category can include a segment of a particular industry. In some embodiments, the merchant category can be defined using merchant category codes according to predefined industries, which can be aligned using standard industrial classification codes, or using the industry categorization described herein.

Merchant categorization indicates the category or categories assigned to each merchant name. As described herein, merchant category information is used primarily for purposes of generating one or more insights and one or more predictive business models based on performance measurement from the comparison of the one or more performance metrics, although other uses are possible. According to one embodiment, each merchant name is associated with only one merchant category. In alternate embodiments, however, merchants are associated with a plurality of categories as apply to their particular businesses. Generally, merchants are categorized according to conventional industry codes as defined by a selected external source (e.g., a merchant category code (MCC), Hoovers™, the North American Industry Classification System (NAICS), and the like). However, in one embodiment, merchant categories are assigned based on system operator preferences, or some other similar categorization process.

An illustrative merchant categorization including industry codes is set forth below.

| INDUSTRY | INDUSTRY NAME |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation Activities |
| ART | Arts and Crafts Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit Reporting |
| CEA | Consumer Electronics/Appliances |
| CES | Cleaning and Exterminating Services |
| CGA | Casino and Gambling Activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications Equipment |
| CTS | Communications, Telecommunications, Cable Services |
| CUE | College, University Education |
| CUF | Clothing, Uniform, Costume Rental |
| DAS | Dating Services |
| DCS | Death Care Services |
| DIS | Discount Department Stores |
| DLS | Drycleaning, Laundry Services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/Beauty/Medical Supplies |
| HCS | Health Care and Social Assistance |
| HFF | Home Furnishings/Furniture |
| HIC | Home Improvement Centers |
| INS | Insurance |
| IRS | Information Retrieval Services |
| JGS | Jewelry and Giftware |
| LEE | Live Performances, Events, Exhibits |
| LLS | Luggage and Leather Stores |
| LMS | Landscaping/Maintenance Services |
| MAS | Miscellaneous Administrative and Waste Disposal Services |
| MER | Miscellaneous Entertainment and Recreation |
| MES | Miscellaneous Educational Services |
| MFG | Manufacturing |
| MOS | Miscellaneous Personal Services |
| MOT | Movie and Other Theatrical |
| MPI | Miscellaneous Publishing Industries |
| MPS | Miscellaneous Professional Services |
| MRS | Maintenance and Repair Services |
| MTS | Miscellaneous Technical Services |
| MVS | Miscellaneous Vehicle Sales |
| OPT | Optical |
| OSC | Office Supply Chains |
| PCS | Pet Care Services |
| PET | Pet Stores |
| PFS | Photofinishing Services |
| PHS | Photography Services |
| PST | Professional Sports Teams |
| PUA | Public Administration |
| RCP | Religious, Civic and Professional Organizations |
| RES | Real Estate Services |
| SGS | Sporting Goods/Apparel/Footwear |
| SHS | Shoe Stores |
| SND | Software Production, Network Services and Data Processing |
| SSS | Security, Surveillance Services |
| TAT | Travel Agencies and Tour Operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training Centers, Seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business Schools |
| WAH | Warehouse |
| WHC | Wholesale Clubs |
| WHT | Wholesale Trade |

In accordance with this disclosure, domestic merchant categorization is important for generating one or more insights and one or more predictive business models based on performance measurement from the comparison of the one or more performance metrics. Proper merchant categorization is important to obtain insights and predictive business models that are truly reflective of the particular merchant and industry, in particular, to determine how purchasing and payment activities of payment card holders is trending for one merchant in comparison to another merchant in the same industry category.

The other information 306 can include, for example, geographic data, demographic data, and the like. In particular, the third set of information can include, for example, geographic data, geographic areas (e.g., ZIP codes, metropolitan areas (metropolitan statistical area (MSA), designated market area (DMA), and the like), event venues, and the like), calendar information (e.g., open seasons such as beach seasons, ski seasons, and the like, retail calendar, seasonal/holiday information such as observances of shifting holidays such as Easter), weather (e.g., snowfall, rain, temperature, and the like), and the like. The third set of information affords leveraged data sources that can supplement information in the first set of information and the second set of information.

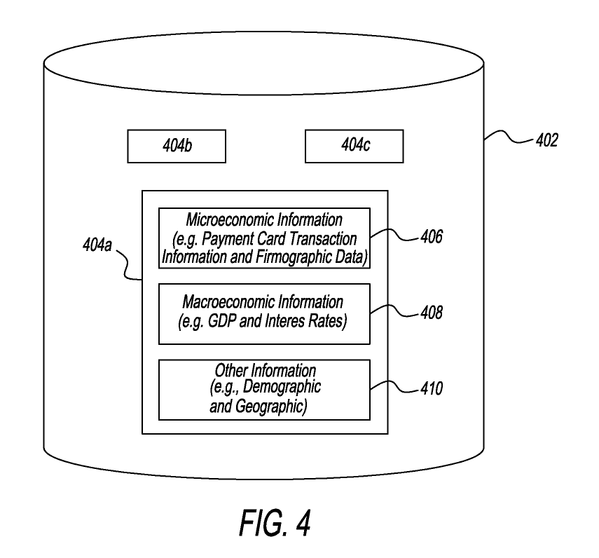

Referring to FIG. 4, an exemplary dataset 402 stores, reviews, and/or analyzes of information used in the systems and methods of this disclosure. The dataset 402 can include a plurality of entries (e.g., entries 404a, 404b, and 404c).

The microeconomic information at 406 includes at least payment card holder transaction information, e.g., payment card billing, purchasing and payment transactions, provided by a payment card company (part of the payment card company network 150 in FIG. 1), merchant information, and firmographics data. The macroeconomic information at 408 includes, for example, gross domestic product (GDP), interest rates, price indices, unemployment rates, and the like.

The payment card transaction information 406 includes payment card transactions and actual spending by payment card holders. More specifically, payment card transaction information 406 can include, for example, payment card transaction information, transaction date and time, transaction amount, payment card holder information (e.g., payment card holder account identifier (likely anonymized), payment card holder geography (potentially modeled), payment card holder type (consumer/business), payment card holder demographics, and the like), and purchasing and payment activities attributable to payment card holders, that can be aggregated by payment card holder, category and/or location, transaction date and time, and transaction amount. The transaction payment card information 406 can also include, for example, a transaction identifier, geolocation of payment card transaction, geolocation date on which payment card transaction occurred, geolocation time on which payment card transaction occurred, and the like. Information for inclusion in the first set of information can be obtained, for example, from payment card companies known as MasterCard®, Visa®, American Express®, and the like (part of the payment card company network 150 in FIG. 1).

The merchant information 408 can include, for example, categories of merchants, merchant name, merchant geography, merchant line of business, and the like. The merchant information 408 can also include, for example, a merchant identifier, geolocation of merchant, and the like.

The other information 410 includes, for example, geographic data, demographic data, and other suitable information that can be useful in conducting the systems and methods of this disclosure.

Algorithms can be employed to determine formulaic descriptions of the integration of the microeconomic information 406, macroeconomic information 408 and optionally the other information 410 using any of a variety of known mathematical techniques. These formulas, in turn, can be used to derive or generate one or more analyses and updates using any of a variety of available trend analysis algorithms. For example, these formulas can be used in the reporting and data analysis, including the storing, reviewing, and/or analyzing of information, for the various purposes described above.

In an embodiment, logic is developed for (i) assessing purchasing and payment activities of the payment card holders; (ii) assessing microeconomic and macroeconomic information that can influence purchasing and payment activities of the payment card holders; and (iii) assessing purchasing and payment behavior of the payment card holders at one or more merchants based on the purchasing and payment activities of the payment card holders. The logic is applied to a universe of foreign payment card holders to identify purchasing and payment activities of the universe of foreign payment card holders at one or more domestic merchants.

In another embodiment, logic is developed for (i) generating one or more insights into the business of the one or more merchants; (ii) identifying opportunities and/or recommendations, based on the one or more insights, for the business of the one or more merchants; (iii) performing operational aspects for implementing the first set of opportunities and/or recommendations into the business of the one or more merchants; (iv) measuring performance of the business of the one or more merchants by comparing one or more performance metrics prior to implementing the first set of opportunities and/or recommendations into the business of the one or more merchants with the one or more performance metrics after implementing the first set of opportunities and/or recommendations into the business of the one or more merchants; and (v) identifying opportunities and/or recommendations, based on performance measurement from the comparison of the one or more performance metrics, for the business of the one or more merchants.

In an embodiment, all information stored in each database can be retrieved. In another embodiment, only a single entry in each of the one or more databases can be retrieved. The retrieval of information can be performed a single time, or can be performed multiple times. In an exemplary embodiment, only information pertaining to a specific predictive behavioral model is retrieved from each of the databases.

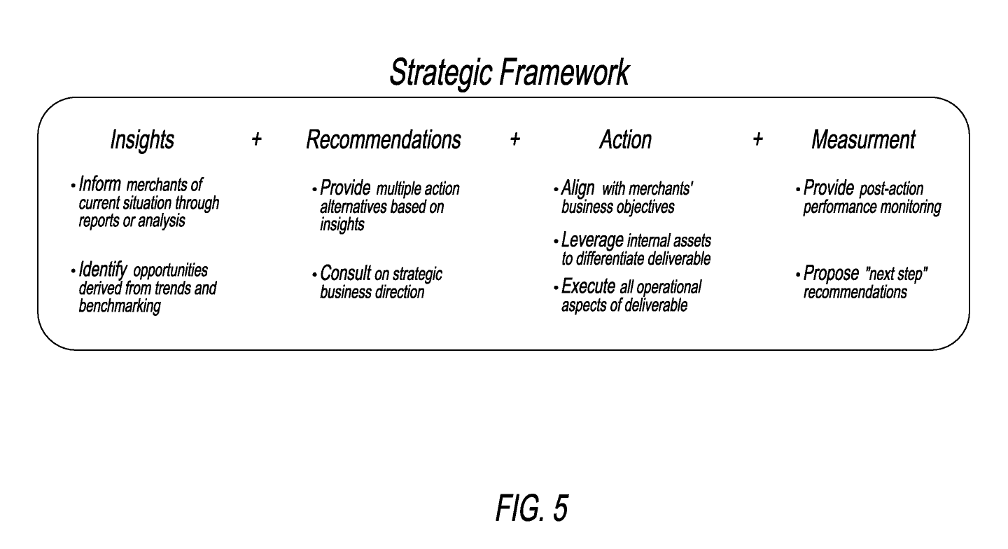

FIG. 5 illustrates an exemplary framework for delivering integrated solutions in accordance with this disclosure. The framework allows an entity (e.g., payment card company) to deliver intelligence, growth and management solutions to another entity (e.g., merchant). The strategic framework shown in FIG. 5 includes insights, recommendations, actions and measurements. Insights include, for example, informing merchants of current situation through reports and analysis, and identifying opportunities derived from trends and benchmarking. Recommendations include, for example, providing multiple action alternatives based on the insights, and consulting on strategic business direction. Actions include, for example, aligning with merchant's business objectives, leveraging internal assets to differentiate deliverables, and executing all operational aspects of the deliverables. Measurements include, for example, providing post-action performance monitoring, and proposing next step recommendations.

In an embodiment, the framework to deliver business solutions to merchants utilizes four components, namely, (i) data driven insights, (ii) opportunity identification and recommendations, (iii) execution and (iv) data driven performance reporting, leading back to components (i) and (ii). These components are normally offered as stand-alone solutions or products/services. However, in accordance with this disclosure, a framework is created that integrates the four components to deliver an end-to-end solution.

In particular, this disclosure allows for creating and delivering integrated solutions using the four components in an integrated framework. With regard to data driven insights, data is utilized such as electronic payment transactions or market indicators to reveal insights into a merchant's business. The insights can reveal trends in spending patterns, customer profiles, competitor performance, market trends, and the like, to help the merchant understand current and future direction of their business and industry. With regard to opportunity identification and recommendations, the data driven insights alert the merchant of changes to their micro and macro business environment that could indicate an opportunity to take action. Additionally, the merchant is provided with a set of recommended actions to select from, based on insight-driven rules or metrics, or the merchant can develop their own strategy and tactics. With regard to execution, the merchant's decision and selections are captured to perform the operational tasks required for implementation, and the operational tasks are executed on behalf of the merchant. With regard to data driven performance reporting, the merchant is provided with performance metrics during and post implementation of their solution. Using metrics and insight-driven rules, the merchant is provided with new opportunities and recommendations on post solution actions.

A marketing campaign is an example of how the strategic framework of this disclosure can be implemented. Utilizing insights driven from payment card transaction data, metrics are delivered to a small business owner (SBO) on payment card usage trends and how competitors are performing relative to the business. From these insights, the SBO is alerted to changes in trends, which provides an opportunity to execute a marketing campaign, intended to take advantage of the trends. Rules, based on the insights, generate a selection of optimal campaign (channel, offer, audience, etc.). The SBO picks from the recommended selections or creates a campaign based on their own preferences, and determines campaign execution requirements from available options. Campaign requirements are executed and performance tracked, returning in-market and post campaign analytics. Rules, based on analytics, generate a new set of recommendations to take advantage of new opportunities created from new insights.

In the context of a marketing campaign, an acquisition strategy can be implemented with market size as the primary insight into the business of the merchant, where the merchant's customer base is either growing or spending more. If market size is increasing, there is a great opportunity to “go deep” locally using direct mail and draw from competitors' customers. If market share is decreasing, this strategy is even more important. If market size is decreasing, the strategic approach is to find more customers outside of the local area using e-mail to increase reach.

Also, in the context of a marketing campaign, a purchasing strategy can be implemented with average purchase size as the primary insight into the business of the merchant. If average purchase size is decreasing, the goal is to drive current customers to spend more with a local direct mail campaign. If average purchase size is increasing, the focus is on encouraging trial from potential customers farther away with an email campaign and strong offer incentives. If purchase frequency is decreasing, the email strategy becomes more important.

Further, in the context of a marketing campaign, a loyalty strategy can be implemented with share of wallet as the primary insight into the business of the merchant. If share of wallet is decreasing, the merchant's customers are spending more with the merchant's competitors. The strategy is to attract current customers through a local direct mail campaign. If share of wallet is increasing, the merchant should expand the target range with an email campaign, attracting customers who will soon make a purchase in their industry.

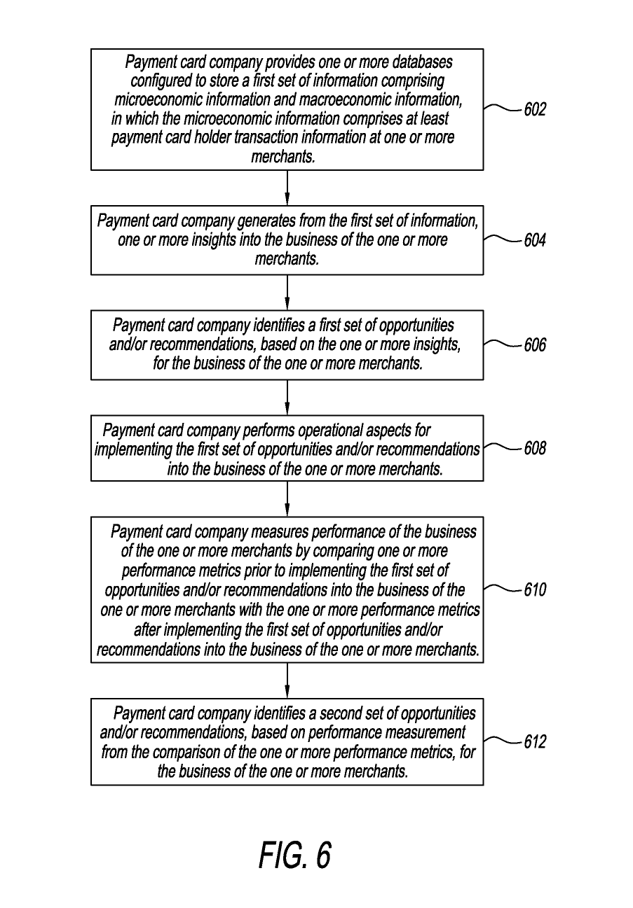

FIG. 6 illustrates an exemplary method for an entity (e.g., payment card company) identifying opportunities and/or recommendations for another entity (e.g., merchant) in accordance with the method of this disclosure. At step 602, a payment card company (part of the payment card company network 150 in FIG. 1) provides one or more databases configured to store a first set of information including microeconomic information and macroeconomic information. The microeconomic information comprises at least payment card holder transaction information at one or more merchants. The payment card holder transaction information includes purchasing and payment information attributable to one or more payment card holders. The information includes payment card transaction information, payment card holder information (e.g., payment card holder account identifier (likely anonymized), payment card holder geography (potentially modeled), payment card holder type (consumer/business), payment card holder demographics, and the like), and purchasing and payment activities attributable to payment card holders. The microeconomic information also includes merchant information. The merchant information includes categories of domestic merchants, domestic merchant name, domestic merchant geography, domestic merchant line of business, firmographics data, and the like. The merchant information also includes, for example, a merchant identifier, geolocation of merchant, and the like. The macroeconomic information comprises gross domestic product (GDP), interest rates, price indices and unemployment rates. The payment card company optionally provides one or more databases configured to store other information including demographic and/or geographic information (not shown in FIG. 6).

In step 604, the payment card company generates, from the information from 602, one or more insights into the business of the one or more merchants. The one or more insights into the business of the one or more merchants can include, for example, one or more of spending patterns, customer profiles, competitor performance, market trends, and the like.

In step 606, the payment card company identifies opportunities and/or recommendations, based on the one or more insights from 604, for the business of the one or more merchants. The opportunities and/or recommendations for the business of the one or more merchants can include, for example, implementing a marketing campaign to take advantage of a market trend, or making targeted promotional offers to a plurality of payment card holders.

In step 608, the payment card company performs operational aspects for implementing the opportunities and/or recommendations into the business of the one or more merchants. The operational aspects can include, for example, providing metrics to the one or more merchants for one or more of spending patterns, customer profiles, competitor performance, and market trends, including payment card usage trends, or alerting the one or more merchants of changes in one or more of spending patterns, customer profiles, competitor performance, and market trends, including payment card usage trends.

In step 610, the payment card company measures performance of the business of the one or more merchants by comparing one or more performance metrics prior to implementing the opportunities and/or recommendations into the business of the one or more merchants with the one or more performance metrics after implementing the opportunities and/or recommendations into the business of the one or more merchants. The one or more performance metrics can include, for example, one or more of financial performance, customer base, product set, cost of goods, cost of advertising, geographical activities, and the like.

In step 612, the payment card company identifies other opportunities and/or recommendations, based on performance measurement from the comparison of the one or more performance metrics in 610, for the business of the one or more merchants. The opportunities and recommendations identified in step 612 can further be incorporated into the one or more databases of step 602 and the methodology carried out one or more additional times or cycles with the benefit of the generated and identified information. This closed loop system affords an even more focused identification of opportunities and/or recommendations for the business of the one or more merchants, benefiting from the use of the information generated during each cycle.

In particular, the generated insights into the business of the merchant, the identified opportunities and/or recommendations for the business of the merchant, the performed operational aspects for implementing the opportunities and/or recommendations into the business of the merchant, the performance measures of the business of the merchant, and any other information generated in one cycle can be incorporated into the one or more databases of step 602 and used in the next or subsequent cycles.

In an embodiment, the merchant provides feedback to the payment card company to enable the payment card company to monitor and track impact of the predictive business model, e.g., targeted promotions and offers. This closed loop system allows the payment card company and the merchant to track, for example, promotional and advertising campaigns, measure efficiency of the targeting, and make any improvements for the next round of promotions or campaigns.

In accordance with this disclosure, one or more predictive business models are generated based at least in part on the information included in the one or more databases. Predictive business models can be selected based on the information obtained and stored in the one or more databases. The selection of information for representation in the predictive business models can be different in every instance. In one embodiment, all information stored in each database can be used for selecting predictive business models. In an alternative embodiment, only a portion of the information is used. The generation and selection of predictive business models can be based on specific criteria.

Predictive business models are generated from the information obtained from the one or more databases. The information is analyzed, extracted and correlated by, for example, a financial transaction processing company (e.g., a payment card company), and can include financial account information, merchant information, performing statistical analysis on financial account information and merchant information, finding correlations between account information, merchant information and payment card holder behaviors, macroeconomic information, other microeconomic information, and the like.

Activities and characteristics attributable to the payment card holders based on the one or more predictive business models are identified. The activities and characteristics attributable to the payment card holders and based on the one or more predictive business models (e.g., a marketing component of the predictive business model) are conveyed by the financial transaction processing entity to the merchant to take appropriate action, for example, making a targeted offer. This conveyance enables a targeted offer to be made by the business merchant to the payment card holders. The transmittal can be performed by any suitable method as will be apparent to persons having skill in the relevant art.

Predictive business models can also be based on behavioral variables. For example, the financial transaction processing entity database can store information relating to financial transactions. The information can be used to determine an individual's likeliness to spend at a particular date and time. An individual's likeliness to spend can be represented generally, or with respect to a particular industry, retailer, brand, or any other criteria that can be suitable as will be apparent to persons having skill in the relevant art. An individual's behavior can also be based on additional factors, including but not limited to, time, location, and season. The factors and behaviors identified can vary widely and can be based on the application of the information. This information can be factored into, for example, a marketing component of the predictive business model.

In an embodiment, the information retrieved from each of the databases can be analyzed to determine behavioral information of the payment card holders. Also, information related to an intention of the payment card holders can be extracted from the behavioral information. The predictive business models (e.g., a marketing component of the predictive business model) can be based upon the behavioral information of the payment card holders and the intent of the payment card holders. The predictive business models can be capable of predicting behavior and intent in the payment card holders.

The one or more predictive business models are capable of predicting behavior and intent in the one or more payment card holders. For example, a marketing component of the predictive business model can be based in part upon the predictive behavior of payment card holders, in particular, based upon the purchasing and payment activities of the payment card holders, the merchants, and the intent of payment card holders. The one or more payment card holders are people and/or businesses; the activities attributable to the one or more payment card holders are purchasing and spending transactions; and the characteristics attributable to the one or more payment card holders are demographics and/or geographical characteristics.

Predictive business models can be updated or refreshed at a specified time (e.g., on a regular basis or upon request of a party). Updating predictive business models can include updating the microeconomic and macroeconomic data including financial data. Predictive business models can also be updated by changing the metrics or attributes that define each predictive business model. The process for updating behavioral information can depend on the circumstances regarding the need for the information itself

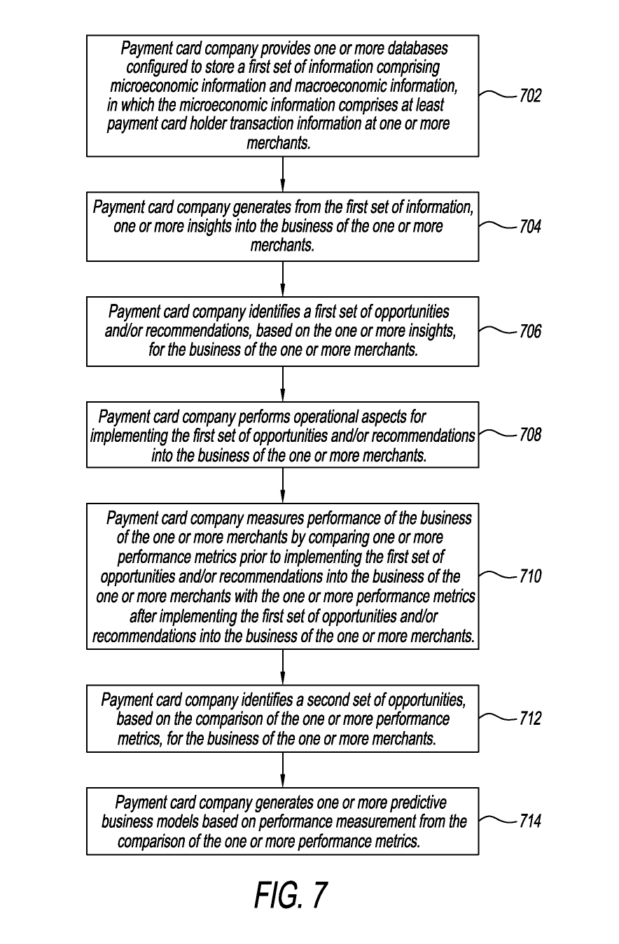

A method for generating one or more predictive business models is an embodiment of this disclosure. Referring to FIG. 7, at step 702, a payment card company (part of the payment card company network 150 in FIG. 1) provides one or more databases configured to store a first set of information including microeconomic information and macroeconomic information. The microeconomic information comprises at least payment card holder transaction information at one or more merchants. The payment card holder transaction information includes purchasing and payment information attributable to one or more payment card holders. The information includes payment card transaction information, payment card holder information (e.g., payment card holder account identifier (likely anonymized), payment card holder geography (potentially modeled), payment card holder type (consumer/business), payment card holder demographics, and the like), and purchasing and payment activities attributable to payment card holders. The microeconomic information also includes merchant information. The merchant information includes categories of domestic merchants, domestic merchant name, domestic merchant geography, domestic merchant line of business, firmographics data, and the like. The merchant information also includes, for example, a merchant identifier, geolocation of merchant, and the like. The macroeconomic information comprises gross domestic product (GDP), interest rates, price indices and unemployment rates. The payment card company optionally provides one or more databases configured to store other information including demographic and/or geographic information (not shown in FIG. 7).

In step 704, the payment card company generates, from the information from 702, one or more insights into the business of the one or more merchants. The one or more insights into the business of the one or more merchants can include, for example, one or more of spending patterns, customer profiles, competitor performance, market trends, and the like.

In step 706, the payment card company identifies opportunities and/or recommendations, based on the one or more insights from 704, for the business of the one or more merchants. The opportunities and/or recommendations for the business of the one or more merchants can include, for example, implementing a marketing campaign to take advantage of a market trend, or making targeted promotional offers to a plurality of payment card holders.

In step 708, the payment card company performs operational aspects for implementing the opportunities and/or recommendations into the business of the one or more merchants. The operational aspects can include, for example, providing metrics to the one or more merchants for one or more of spending patterns, customer profiles, competitor performance, and market trends, including payment card usage trends, or alerting the one or more merchants of changes in one or more of spending patterns, customer profiles, competitor performance, and market trends, including payment card usage trends. In an alternate embodiment, the merchant performs the operational aspects for implementing the opportunities and/or recommendations into their business, for example, marketing campaigns (e.g., self-serve online platform capable of deploying marketing campaigns).

In step 710, the payment card company measures performance of the business of the one or more merchants by comparing one or more performance metrics prior to implementing the opportunities and/or recommendations into the business of the one or more merchants with the one or more performance metrics after implementing the opportunities and/or recommendations into the business of the one or more merchants. The one or more performance metrics can include, for example, one or more of financial performance, customer base, product set, cost of goods, cost of advertising, geographical activities, and the like.

In step 712, the payment card company identifies other opportunities and/or recommendations, based on performance measurement from the comparison of the one or more performance metrics in 710, for the business of the one or more merchants. The opportunities and recommendations identified in step 712 can further be incorporated into the one or more databases of step 702 and the methodology carried out one or more additional times or cycles with the benefit of the generated and identified information. This closed loop system affords an even more focused identification of opportunities and/or recommendations for the business of the one or more merchants, benefiting from the use of the information generated during each cycle.

At step 714, the payment card company generates one or more predictive business models based on performance measurement from the comparison of the one or more performance metrics in step 710.

In particular, the generated insights into the business of the merchant, the identified opportunities and/or recommendations for the business of the merchant, the performed operational aspects for implementing the opportunities and/or recommendations into the business of the merchant, the performance measures of the business of the merchant, the predictive business models, and any other information generated in one cycle can be incorporated into the one or more databases of step 702 and used in the next or subsequent cycles.

The predictive business models can include, for example, a marketing component based in part upon the predictive behavior of payment card holders, in particular, based upon the purchasing and payment activities of the payment card holders, the merchants, and the intent of payment card holders. The payment card holders have a propensity to carry out certain activities based on the predictive behavior.

The payment card company identifies activities and characteristics attributable to payment card holders (e.g., potential consumers) based on the predictive behavior. As part of a marketing component of the predictive business model, the activities and characteristics attributable to the payment card holders based on the predictive behavior are conveyed to an entity, to enable the entity, such as a merchant, to make a promotion or targeted offer to the payment card holders.

It will be understood that the present disclosure may be embodied in a computer readable non-transitory storage medium storing instructions of a computer program which when executed by a computer system results in performance of steps of the method described herein. Such storage media may include any of those mentioned in the description above.

Where methods described above indicate certain events occurring in certain orders, the ordering of certain events may be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
providing one or more databases configured to store a first set of information comprising microeconomic information and macroeconomic information, wherein said microeconomic information comprises at least payment card holder transaction information at one or more merchants;
generating, from the first set of information, one or more insights into the business of the one or more merchants;
identifying a first set of opportunities and/or recommendations, based on the one or more insights, for the business of the one or more merchants;
performing operational aspects for implementing the first set of opportunities and/or recommendations into the business of the one or more merchants;
measuring performance of the business of the one or more merchants by comparing one or more performance metrics prior to implementing the first set of opportunities and/or recommendations into the business of the one or more merchants with the one or more performance metrics after implementing the first set of opportunities and/or recommendations into the business of the one or more merchants; and
identifying a second set of opportunities and/or recommendations, based on performance measurement from the comparison of the one or more performance metrics, for the business of the one or more merchants.

2. The method of claim 1, comprising a closed loop method in which at least one of the generated one or more insights into the business of the one or more merchants, the identified opportunities and/or recommendations for the business of the one or more merchants, the performed operational aspects for implementing the opportunities and/or recommendations into the business of the one or more merchants, the performance measures of the business of the one or more merchants, and any other information generated in a cycle is incorporated into the one or more databases and used in a subsequent cycle.

3. The method of claim 1, further comprising:
providing one or more databases configured to store a second set of information comprising business performance information of one or more merchants obtained by comparing one or more performance metrics prior to implementing the first set of opportunities and/or recommendations into the business of the one or more merchants with the one or more performance metrics after implementing the first set of opportunities and/or recommendations into the business of the one or more merchants;
generating, from the first set of information and the second set of information, one or more insights into the business of the one or more merchants;
identifying a third set of opportunities and/or recommendations, based on the one or more insights, for the business of the one or more merchants;
performing operational aspects for implementing the third set of opportunities and/or recommendations into the business of the one or more merchants;
measuring performance of the business of the one or more merchants by comparing one or more performance metrics prior to implementing the third set of opportunities and/or recommendations into the business of the one or more merchants with the one or more performance metrics after implementing the third set of opportunities and/or recommendations into the business of the one or more merchants; and
identifying a fourth set of opportunities and/or recommendations, based on performance measurement from the comparison of the one or more performance metrics, for the business of the one or more merchants.

4. The method of claim 2, further comprising:
providing one or more databases configured to store a third set of information comprising other information, wherein the other information comprises geographic data and demographic data.

5. The method of claim 2, wherein the microeconomic information comprises payment card holder billing, purchasing and payment transactions, and firmographic information, and the macroeconomic information comprises gross domestic product (GDP), interest rates, price indices and unemployment rates.

6. The method of claim 2, wherein the one or more insights into the business of the one or more merchants comprise one or more of spending patterns, customer profiles, competitor performance, and market trends.

7. The method of claim 2, wherein the opportunities and/or recommendations for the business of the one or more merchants comprise (a) implementing a marketing campaign to take advantage of a market trend or (b) making targeted promotional offers to a plurality of payment card holders.

8. The method of claim 2, wherein the operational aspects comprise (a) providing metrics to the one or more merchants for one or more of spending patterns, customer profiles, competitor performance, and market trends, including payment card usage trends, or (b) alerting the one or more merchants of changes in one or more of spending patterns, customer profiles, competitor performance, and market trends, including payment card usage trends.

9. The method of claim 2, wherein the one or more performance metrics comprise one or more of financial performance, customer base, product set, cost of goods, cost of advertising, and geographical activities.

10. The method of claim 2, further comprising creating one or more datasets to store information relating to (i) the first set of information including payment card holder transaction information at one or more merchants, (ii) one or more insights, generated from the first set of information, into the business of the one or more merchants, (iii) opportunities and/or recommendations, generated from the one or more insights, for the business of the one or more merchants, (iv) operational aspects performed to implement the opportunities and/or recommendations into the business of the one or more merchants, (v) business performance measurement information of one or more merchants generated by comparison of the one or more performance metrics, and (vi) opportunities and/or recommendations, generated from the business performance measurement information, for the business of the one or more merchants.

11. The method of claim 2, further comprising:
generating one or more predictive business models based on the comparison of the one or more performance metrics.

12. The method of claim 2, further comprising (i) algorithmically generating, from the first set of information, one or more insights into the business of the one or more merchants, and (ii) algorithmically generating, from the second set of information, one or more insights into the business of the one or more merchants.

13. A system comprising:
one or more databases configured to store a first set of information comprising microeconomic information and macroeconomic information, wherein said microeconomic information comprises at least payment card holder transaction information at one or more merchants;
a processor configured to:
generate, from the first set of information, one or more insights into the business of the one or more merchants;
identify a first set of opportunities and/or recommendations, based on the one or more insights, for the business of the one or more merchants;
perform operational aspects for implementing the first set of opportunities and/or recommendations into the business of the one or more merchants;
measure performance of the business of the one or more merchants by comparing one or more performance metrics prior to implementing the first set of opportunities and/or recommendations into the business of the one or more merchants with the one or more performance metrics after implementing the first set of opportunities and/or recommendations into the business of the one or more merchants; and
identify a second set of opportunities and/or recommendations, based on performance measurement from the comparison of the one or more performance metrics, for the business of the one or more merchants.

14. The system of claim 13, wherein the processor is configured to carry out a closed loop method in which at least one of the generated one or more insights into the business of the one or more merchants, the identified opportunities and/or recommendations for the business of the one or more merchants, the performed operational aspects for implementing the opportunities and/or recommendations into the business of the one or more merchants, the performance measures of the business of the one or more merchants, and any other information generated in a cycle is incorporated into the one or more databases and used in a subsequent cycle.

15. The system of claim 13, further comprising:
one or more databases configured to store a second set of information comprising business performance information of one or more merchants obtained by comparing one or more performance metrics prior to implementing the first set of opportunities and/or recommendations into the business of the one or more merchants with the one or more performance metrics after implementing the first set of opportunities and/or recommendations into the business of the one or more merchants;
a processor configured to:
generate, from the first set of information and the second set of information, one or more insights into the business of the one or more merchants;
identify a third set of opportunities and/or recommendations, based on the one or more insights, for the business of the one or more merchants;
perform operational aspects for implementing the third set of opportunities and/or recommendations into the business of the one or more merchants;
measure performance of the business of the one or more merchants by comparing one or more performance metrics prior to implementing the third set of opportunities and/or recommendations into the business of the one or more merchants with the one or more performance metrics after implementing the third set of opportunities and/or recommendations into the business of the one or more merchants; and
identify a fourth set of opportunities and/or recommendations, based on performance measurement from the comparison of the one or more performance metrics, for the business of the one or more merchants.

16. The system of claim 14, further comprising:
one or more databases configured to store a third set of information comprising other information, wherein the other information comprises geographic data and demographic data.

17. The system of claim 14, wherein the microeconomic information comprises payment card holder billing, purchasing and payment transactions, and firmographic information, and the macroeconomic information comprises gross domestic product (GDP), interest rates, price indices and unemployment rates.

18. The system of claim 14, wherein the one or more insights into the business of the one or more merchants comprise one or more of spending patterns, customer profiles, competitor performance, and market trends.

19. The system of claim 14, wherein the opportunities and/or recommendations for the business of the one or more merchants comprise (a) implementing a marketing campaign to take advantage of a market trend or (b) making targeted promotional offers to a plurality of payment card holders.

20. The system of claim 14, wherein the operational aspects comprise (a) providing metrics to the one or more merchants for one or more of spending patterns, customer profiles, competitor performance, and market trends, including payment card usage trends, or (b) alerting the one or more merchants of changes in one or more of spending patterns, customer profiles, competitor performance, and market trends, including payment card usage trends.

21. The system of claim 14, wherein the one or more performance metrics comprise one or more of financial performance, customer base, product set, cost of goods, cost of advertising, and geographical activities.

22. The system of claim 14, further comprising one or more datasets to store information relating to (i) the first set of information including payment card holder transaction information at one or more merchants, (ii) one or more insights, generated from the first set of information, into the business of the one or more merchants, (iii) opportunities and/or recommendations, generated from the one or more insights, for the business of the one or more merchants, (iv) operational aspects performed to implement the opportunities and/or recommendations into the business of the one or more merchants, (v) business performance measurement information of one or more merchants generated by comparison of the one or more performance metrics, and (vi) opportunities and/or recommendations, generated from the business performance measurement information, for the business of the one or more merchants.

23. The system of claim 14, wherein the processor is configured to generate one or more predictive business models based on the comparison of the one or more performance metrics.

24. The system of claim 14, wherein the processor is configured to (i) algorithmically generate, from the first set of information, one or more insights into the business of the one or more merchants, and (ii) algorithmically generate, from the second set of information, one or more insights into the business of the one or more merchants.

25. A method for generating one or more predictive business models, the method comprising:
providing one or more databases configured to store a first set of information comprising microeconomic information and macroeconomic information, wherein said microeconomic information comprises at least payment card holder transaction information at one or more merchants;
generating, from the first set of information, one or more insights into the business of the one or more merchants;
identifying a first set of opportunities and/or recommendations, based on the one or more insights, for the business of the one or more merchants;
performing operational aspects for implementing the first set of opportunities and/or recommendations into the business of the one or more merchants;
measuring performance of the business of the one or more merchants by comparing one or more performance metrics prior to implementing the first set of opportunities and/or recommendations into the business of the one or more merchants with the one or more performance metrics after implementing the first set of opportunities and/or recommendations into the business of the one or more merchants;
identifying a second set of opportunities and/or recommendations, based on the comparison of the one or more performance metrics, for the business of the one or more merchants; and
generating one or more predictive business models based on performance measurement from the comparison of the one or more performance metrics.

26. The method of claim 25, comprising a closed loop method in which at least one of the generated one or more insights into the business of the one or more merchants, the identified opportunities and/or recommendations for the business of the one or more merchants, the performed operational aspects for implementing the opportunities and/or recommendations into the business of the one or more merchants, the performance measures of the business of the one or more merchants, the one or more predictive business models, and any other information generated in a cycle is incorporated into the one or more databases and used in a subsequent cycle.

27. The method of claim 25, further comprising:
providing one or more databases configured to store a second set of information comprising business performance information of one or more merchants obtained by comparing one or more performance metrics prior to implementing the first set of opportunities and/or recommendations into the business of the one or more merchants with the one or more performance metrics after implementing the first set of opportunities and/or recommendations into the business of the one or more merchants;
generating, from the second set of information, one or more insights into the business of the one or more merchants;
identifying a third set of opportunities and/or recommendations, based on the one or more insights, for the business of the one or more merchants;
performing operational aspects for implementing the third set of opportunities and/or recommendations into the business of the one or more merchants;
measuring performance of the business of the one or more merchants by comparing one or more performance metrics prior to implementing the third set of opportunities and/or recommendations into the business of the one or more merchants with the one or more performance metrics after implementing the third set of opportunities and/or recommendations into the business of the one or more merchants;
identifying a fourth set of opportunities and/or recommendations, based on performance measurement from the comparison of the one or more performance metrics, for the business of the one or more merchants; and
generating one or more predictive business models based on performance measurement from the comparison of the one or more performance metrics.
